(19) United States
(12) Patent Application Publication
(10) Pub. No.: US 2013/0110516 A1
(43) Pub. Date: May 2, 2013

(54) VESSEL SUCH AS A PILL BOTTLE WITH CONTENTS DESCRIBING VOICE STORING AND REPRODUCING MEANS AND METHOD

(71) Applicants: Ramzi ABULHAJ, Charlotte, NC (US); Rick ADMANI, Charlotte, NC (US); William BAXTER, Charlotte, NC (US); Amr SHEHAB, Charlotte, NC (US); Moo Nam KO, Charlotte, NC (US); Dennis HANKS, Charlotte, NC (US)

(72) Inventors: Ramzi ABULHAJ, Charlotte, NC (US); Rick ADMANI, Charlotte, NC (US); William BAXTER, Charlotte, NC (US); Amr SHEHAB, Charlotte, NC (US); Moo Nam KO, Charlotte, NC (US); Dennis HANKS, Charlotte, NC (US)

(73) Assignee: PRODIGY DIABETES CARE, LLC, Charlotte, NC (US)

(21) Appl. No.: 13/455,648

(22) Filed: Apr. 25, 2012

Related U.S. Application Data
(63) Continuation-in-part of application No. 12/927,044, filed on Nov. 5, 2010, now abandoned.

(51) Int. Cl. G10L 21/00

(52) U.S. Cl. CPC G10L 21/00
USPC 704/274

(57) ABSTRACT

A bottle assembly that provides an audio message related to its contents, including: a first housing configured to contain the contents; a second housing coupled to the first housing; an audio system selectively attached to the second housing; a printed circuit board disposed within the audio system including a memory configured to receive audio data; and a speaker and battery disposed within the audio system and coupled to the printed circuit board; the audio system has a keyed shape and is configured to mate with a similarly-shaped receptacle of an audio data programming system when the audio system is detached from the second housing. The audio system has a keyed shape such that it may be mated with the audio data programming system in only one orientation for programming. Preferably, the audio data programming system is disposed within a pharmacy and the audio data is generated outside of the pharmacy.

### CROSS-REFERENCE TO RELATED APPLICATION(S)

The present patent application/patent is a continuation-in-part of co-pending U.S. patent application Ser. No. 12/927,044, filed on Nov. 5, 2010, and entitled “VESSEL SUCH AS A PILL BOTTLE WITH CONTENTS DESCRIBING VOICE STORING AND REPRODUCING MEANS AND METHOD,” the contents of which are incorporated in full by reference herein.

### FIELD OF THE INVENTION

The present invention relates generally to vessels, variously also referred to herein as containers or bottles, for containing prescription medications and the like. More specifically, the present invention relates to bottles that may be used by the visually impaired and others that are programmed with audio data such that, upon selective activation, the audio data provides an audio message in a programmed or recorded form to a patient or other user including patient/prescription (i.e. label) information, medication identification, instructions for administration, and the like. This audio data is programmed into the bottles by a supplier upon filling, for example. The present invention further relates to a method by which the audio data is programmed into the bottles by a pharmacist or the like via a remotely-located application and onsite utility station.

### BACKGROUND OF THE INVENTION

Bottles containing prescription medications and the like typically include a printed label including patient/prescription information, medication identification, instructions for administration, and the like. Such printed labels, however, are typically unreadable by the visually impaired, the elderly, and others. This is a significant problem given the fact that there are 22-25 million blind persons, and less than about 10% of them read brail, while many of them take numerous prescription medications daily to control heart conditions, diabetes, etc. In order to address this problem, several “talking pill bottles” and “talking bottle caps” have been developed. Most of these, however, include a cumbersome and expensive module or apparatus that a conventional bottle or the like plugs into or mates with. This arrangement, in addition to being complex and expensive, is not conducive to the mass filling and shipment of prescription medications by mail, for example, which represents the future of prescription medication delivery.

Thus, what is needed in the art is a “talking pill bottle” that is simple, inexpensive, and suitable for the mass filling and shipment of prescription medications by mail, for example. In essence, this “talking pill bottle” would be produced with the understanding that it is disposable. Accordingly, it should be simple and inexpensive to manufacture and contain a minimum of components that would generate unnecessary waste. Further, what is need is a “talking pill bottle” that is easily programmable by a pharmacist or the like via a remotely-located application and onsite utility station, such that the programming service provider does not have to have access to the patient database(s) of the pharmacist or the like in order to provide programming services.

### BRIEF SUMMARY OF THE INVENTION

In various exemplary embodiments, the present invention provides a bottle for containing a prescription medication or other identifiable contents that includes an upper chamber separated from a lower chamber or recess, wherein the two compartments or portions are axially aligned. Throughout this description, the terms “upper” and “lower” are used freely, but do not necessarily denote a specific spatial relationship. In this regard, “upper” may simply be read as “first” and “lower” may simply be read as “second,” for example. In this regard, the bottle resembles a conventional pill bottle or the like. The upper chamber houses the prescription medication or other identifiable contents and the lower chamber or recess houses the components of the audio system. The upper and lower chambers may be formed by separate housings or concentric walls that are subsequently joined together, or they may be integrally formed. The audio system generally includes a speaker and a battery that are selectively mated with a grill assembly having a hinged or other button. The grill assembly retains a printed circuit board that includes electronics that store the audio data in a memory store and otherwise electronically couples the components of the audio system. Thus, the printed circuit board includes programming/recording and playback electronics well known to those of ordinary skill in the art. For example, such electronics are now commonly used in the greeting card industry. The printed circuit board also includes one or more activation buttons that physically communicate with the hinged or other button of the grill assembly and are selectively depressed thereby to play the audio data. Opposite the one or more buttons, the other side of the printed circuit board, for example, includes a plurality of concentrically-arranged contact surfaces that selectively engage an external line or other arrangement of pins that are used to program the audio system during the programming process prior to shipping using an external computer. During the filling process, for example, the audio system is typically programmed as the bottle label is generated and affixed, before the audio system is coupled to the lower chamber or recess of the bottle. This provides a security check as to the contents of the bottle. Greater detail will be provided herein with regard to each of these components. It will be readily apparent to those of ordinary skill in the art that the printed circuit board may contain any suitable components and/or connections for providing power, recording, and playback functionalities. User recording options are also contemplated herein.

In one exemplary embodiment, the present invention provides a bottle assembly that selectively provides an audio message related to its contents, including: an upper housing configured to contain the contents; a lower housing coupled to the upper housing; a printed circuit board disposed within the lower housing and including a memory configured to receive audio data; a grill assembly coupled to the printed circuit board; and a speaker and a battery coupled to the grill assembly between the grill assembly and the printed circuit board; wherein a surface of the printed circuit board opposite the speaker and the battery includes one or more concentrically-arranged electrical contact surfaces by which the audio data is programmed into the memory. Optionally, the upper housing and the lower housing each have a substantially-cylindrical shape. Optionally, the upper housing and the lower housing are integrally formed. Optionally, a wall of the lower housing defines one or more leg members and one or more retention members configured to retain the grill assembly. Optionally, the printed circuit board includes one or more buttons configured to selectively activate and play the audio data programmed into the memory; and the grill assembly includes a hinged button coupled to the one or more buttons of the printed circuit board and configured to selectively actuate the one or more buttons upon depression by a user. Optionally, the speaker and the battery are disposed within a plurality of wells manufactured into an interior surface of the grill assembly. Preferably, the contents consist of a medication.

In another exemplary embodiment, the present invention provides a method for providing a bottle assembly that selectively provides an audio message related to its contents, including: providing an upper housing configured to contain the contents; providing a lower housing coupled to the upper housing; providing a printed circuit board disposed within the lower housing and including a memory configured to receive audio data; providing a grill assembly coupled to the printed circuit board; and providing a speaker and a battery coupled to the grill assembly between the grill assembly and the printed circuit board; wherein a surface of the printed circuit board opposite the speaker and the battery includes one or more concentrically-arranged electrical contact surfaces by which the audio data is programmed into the memory. Optionally, the upper housing and the lower housing each have a substantially-cylindrical shape. Optionally, the upper housing and the lower housing are integrally formed. Optionally, a wall of the lower housing defines one or more leg members and one or more retention members configured to retain the grill assembly. Optionally, the printed circuit board includes one or more buttons configured to selectively activate and play the audio data programmed into the memory; and the grill assembly includes a hinged button coupled to the one or more buttons of the printed circuit board and configured to selectively actuate the one or more buttons upon depression by a user. Optionally, the speaker and the battery are disposed within a plurality of wells manufactured into an interior surface of the grill assembly. Preferably, the contents consist of a medication.

In a further exemplary embodiment, the present invention provides a bottle assembly that selectively provides an audio message related to its contents, including: an upper housing configured to contain the contents; a lower housing coupled to the upper housing; a printed circuit board disposed within the lower housing and including a memory configured to receive audio data; and a grill assembly coupled to the printed circuit board; wherein a surface of the printed circuit board opposite the grill assembly includes one or more concentrically-arranged electrical contact surfaces by which the audio data is programmed into the memory. Optionally, the upper housing and the lower housing each have a substantially-cylindrical shape. Optionally, the upper housing and the lower housing are integrally formed. Optionally, a wall of the lower housing defines one or more leg members and one or more retention members configured to retain the grill assembly. Optionally, the printed circuit board includes one or more buttons configured to selectively activate and play the audio data programmed into the memory; and the grill assembly includes a hinged button coupled to the one or more buttons of the printed circuit board and configured to selectively actuate the one or more buttons upon depression by a user. Optionally, the one or more concentrically-arranged electrical contact surfaces include contacts for various functionalities, either alone or in combination. Preferably, the contents consist of a medication.

In a still further exemplary embodiment, the present invention provides a bottle assembly that selectively provides an audio message related to its contents, including: a lower housing configured to contain the contents; an upper housing coupled to the lower housing; a voice chip disposed within the upper housing; a memory chip disposed within the upper housing and coupled to the voice chip, wherein the memory chip is configured to receive audio data; and one or more electrical contact surfaces by which the audio data is programmed into the memory chip. Optionally, the audio data is received via a 4-pin connection. Optionally, the audio data is received while the voice chip is in a standby mode. Optionally, the audio data is received with clocking control. In use, the bottle assembly also includes a programming station that is selectively coupled to the one or more electrical contact surfaces and used to program the memory chip. Optionally, the programming station is in communication with a product provider shared database. Alternatively, the programming station reads a barcode to program the memory chip. Preferably, the contents consist of a medication.

In a still further exemplary embodiment, the present invention provides a container assembly that selectively provides an audio message related to its contents, including: a first housing configured to contain the contents; a second housing coupled to the first housing; an audio system selectively attached to the second housing; a printed circuit board disposed within the audio system and including a memory configured to receive audio data; and a speaker and a battery disposed within the audio system and coupled to the printed circuit board; wherein the audio system has a keyed shape and is configured to mate with a similarly-shaped receptacle of an audio data programming system when the audio system is detached from the second housing. Optionally, the first housing and the second housing are integrally formed. Optionally, the first housing and the second housing are separately formed. Optionally, a wall of the second housing defines one or more leg members and one or more retention members configured to retain the audio system. The printed circuit board comprises at least one button configured to selectively activate and play the audio data programmed into the memory. Optionally, the speaker and the battery are disposed within an interior surface of the audio system, and the interior surface of the audio system comprises at least one button corresponding to the at least one button of the printed circuit board. Optionally, the contents include a medication. The printed circuit board includes a plurality of contacts that are accessible through the audio system by which the audio data programmed into the memory is programmed by the audio data programming system. Optionally, the plurality of contacts are linearly aligned or aligned in another fixed pattern. The audio system has a keyed shape such that it may be mated with the audio data programming system in only one orientation for programming. Preferably, the audio data programming system is disposed within a pharmacy and the audio data is generated one or more of outside of and inside the pharmacy.

In a still further exemplary embodiment, the present invention provides a method for programming a container assembly that selectively provides an audio message related to its contents, including: receiving information related to the contents into a locally-disposed programming module; transmitting the information related to the contents to a remotely-disposed programming service provider system; at the remotely-disposed programming service provider system, converting the information related to the contents into an audio file using a text-to-speech conversion algorithm; transmitting the audio file to the locally-disposed programming module; and at the locally-disposed programming module, programming an audio system of the container assembly using the audio file. The method also includes previewing a portion of the audio file at the locally-disposed programming module and modifying a portion of the information related to the contents responsive to the previewed audio file. The method further includes encrypting the information related to the contents. The method still further includes, at the remotely-disposed programming service provider system, decrypting the information related to the contents. The audio system has a keyed shape such that it may be mated with the locally-disposed programming module in only one orientation for programming. Optionally, receiving the information related to the contents into the locally-disposed programming module includes receiving the information related to the contents into the locally-disposed programming module from one or more of a one-dimensional barcode and a two-dimensional barcode.

### BRIEF DESCRIPTION OF THE DRAWINGS

The present invention is illustrated and described herein with reference to the various drawings, in which like reference numbers are used to denote like system components and/or method steps, as appropriate, and in which:

FIG. 1 is a planar side view illustrating one exemplary embodiment of the bottle assembly of the present invention;

FIG. 2 is perspective view highlighting the configuration of the lower chamber of the bottle assembly of FIG. 1;

FIG. 3 is an exploded perspective view highlighting the configuration of the audio system of the bottle assembly of FIG. 1;

FIG. 4 is a perspective view highlighting the configuration of the grill assembly of the bottle assembly of FIG. 1;

FIG. 5 is a perspective view highlighting the configuration of the grill assembly, speaker, and battery of the bottle assembly of FIG. 1;

FIG. 6 is a perspective view highlighting the configuration of the grill assembly and printed circuit board of the bottle assembly of FIG. 1;

FIG. 7 is a perspective view highlighting the configuration of the grill assembly installed in the lower chamber or recess of the bottle assembly of FIG. 1;

FIG. 8 is a schematic view illustrating another exemplary embodiment of the bottle assembly of the present invention;

FIG. 9 is a schematic view illustrating one exemplary embodiment of the logic configuration of the bottle assemblies of the present invention;

FIG. 10 is a schematic view illustrating one exemplary embodiment of the data exchange and hardware interface of the bottle assemblies of the present invention;

FIG. 11 is a schematic view illustrating one exemplary embodiment of the barcode interface of the bottle assemblies of the present invention;

FIG. 12 is a schematic view illustrating one exemplary embodiment of the barcode record layout of the bottle assemblies of the present invention;

FIG. 13 is a schematic view illustrating one exemplary embodiment of the smart pill bottle application framework of the present invention;

FIG. 14 is a schematic view illustrating one exemplary embodiment of a keyed programmable audio system of the present invention; and

FIG. 15 is a schematic view illustrating one exemplary embodiment of an audio programming architecture of the present invention.

### DETAILED DESCRIPTION OF THE INVENTION

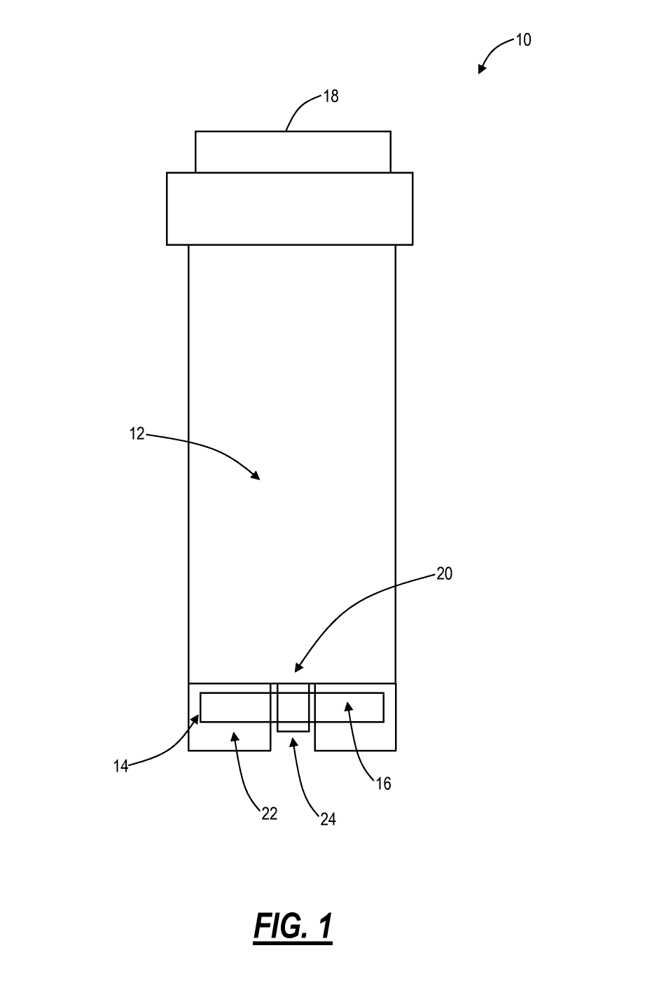

Referring to FIG. 1, in one exemplary embodiment, the present invention provides a bottle assembly 10 for containing a prescription medication or other identifiable contents that includes an upper (or first) chamber 12 separated from a lower (or second) chamber or recess 14, wherein the two compartments or portions are axially aligned. In this regard, the bottle assembly 10 resembles a conventional pill bottle or the like, with a generally tubular configuration, for example. It may be constructed of a moldable or formable plastic material or the like. The upper chamber 12 houses the prescription medication or other identifiable contents and the lower chamber or recess 14 houses the components of the audio system 16. Accordingly, the upper chamber 12 includes a child-proof cap 18 or the like that is selectively used to close it. The upper and lower chambers 12 and 14 may be formed by separate housings or concentric walls that are subsequently joined together, or they may be integrally formed. Generally, the upper and lower chambers 12 and 14 are separated by a concentric dividing wall 20. Optionally, the walls of the lower chamber or recess 14 define one or more leg portions 22 and one or more retaining arms 24, the one or more leg portions 22 protruding below the level of the audio system 16 such that the bottle assembly 10 stands securely when placed on a flat surface without balancing on the audio system 16 and the one or more retaining arms 24 retaining the audio system 16 within the lower chamber or recess 14 once the audio system 16 is “snapped” into place. It will be readily apparent to those of ordinary skill in the art that other stabilization methods and other retention mechanisms may be used with equal degrees of success. As used herein, “upper” and “lower” chambers and recesses are also intended to denote comparable separate compartments in other configurations, such that their vertical arrangement may be switched, they may be side by side, etc. In this sense, “upper” and “lower” are intended to cover all equivalent configurations and are relativistic only.

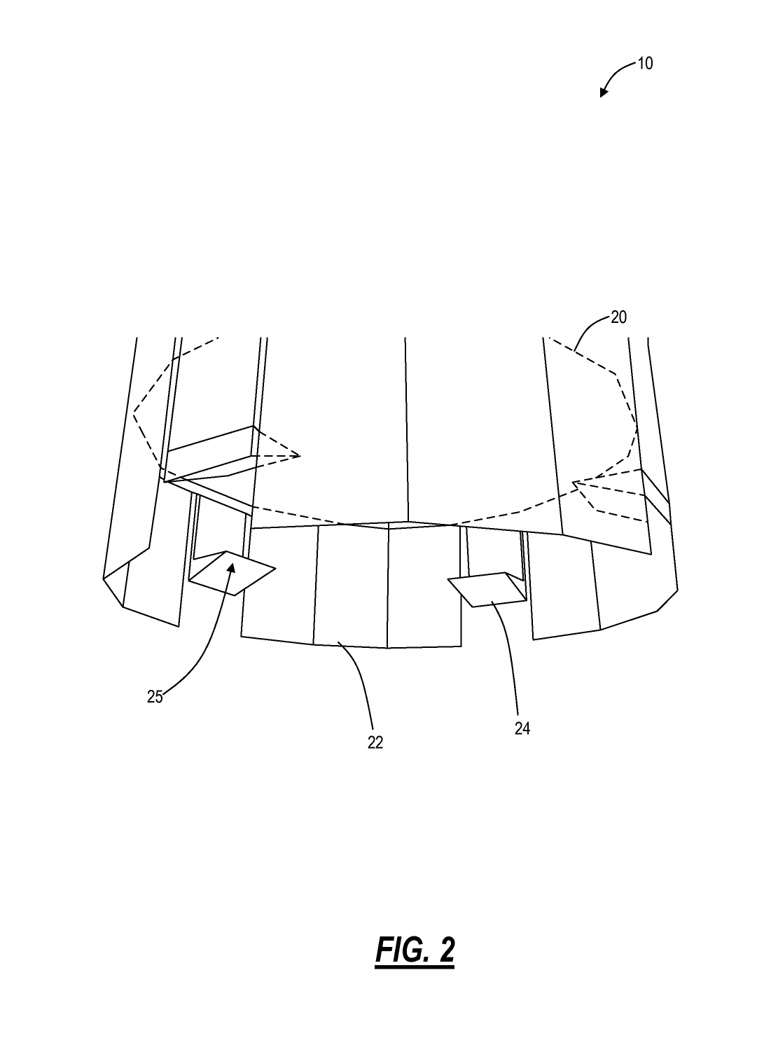

The configuration of the one or more leg portions 22 and the one or more retaining arms 24 of this exemplary embodiment are shown in greater detail in FIG. 2, with the one or more leg portions 22 being formed by elongate, arcuate extensions of the wall forming the lower chamber or recess 14 and the one or more retaining arms 24 being formed by intermediate extensions of the wall forming the lower chamber or recess 14, each of the one or more retaining arms 24 including a hook portion 25 that selectively engages the audio system 16.

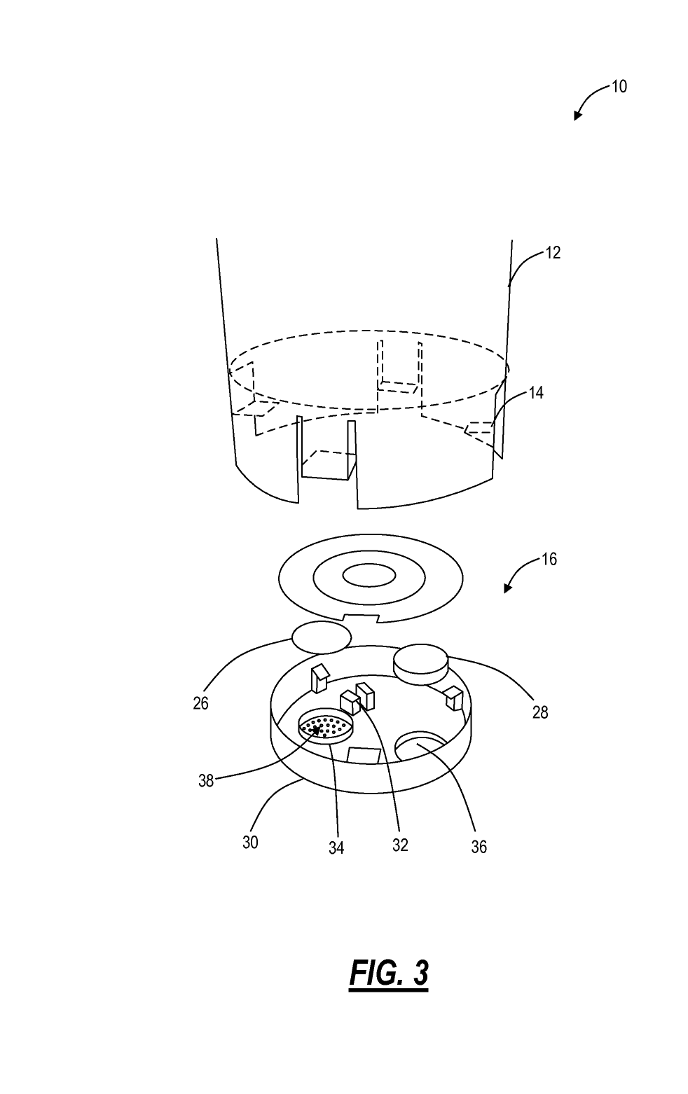

Referring to FIG. 3, in one exemplary embodiment, the digital sound system 16 generally includes a speaker 26 and a battery 28 that are selectively mated with a grill assembly 30 having a hinged or other button 32 during assembly. This mating may be accomplished via press fitting or the like.

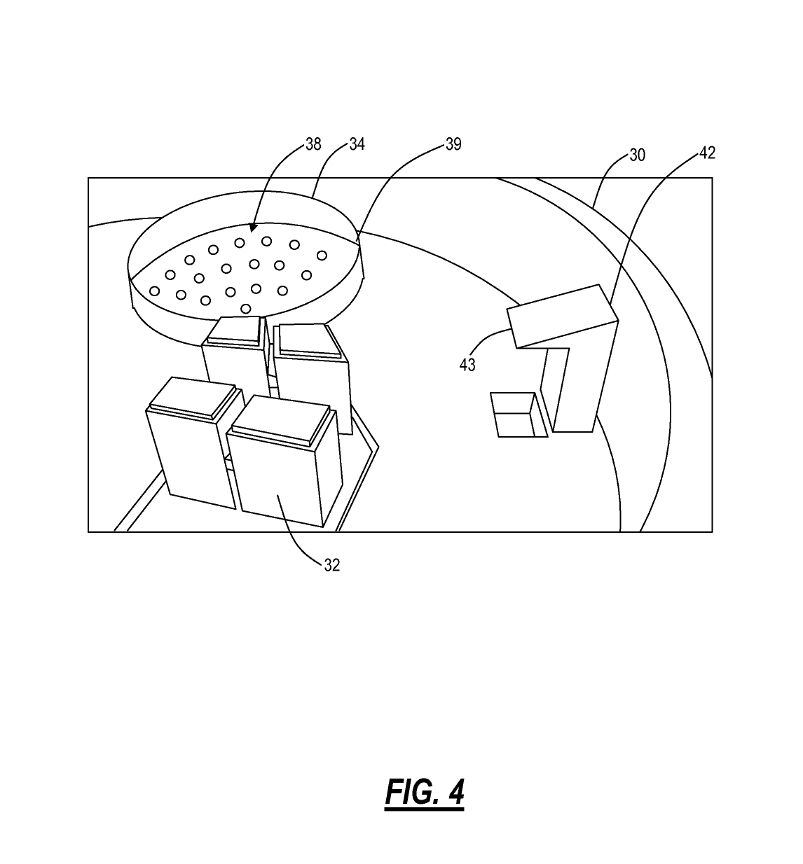

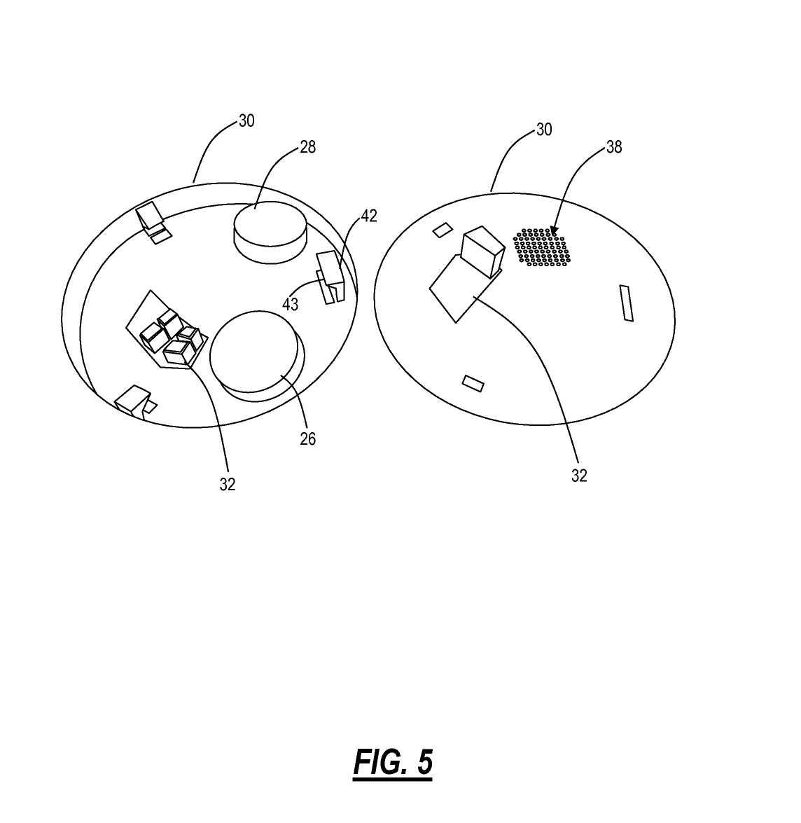

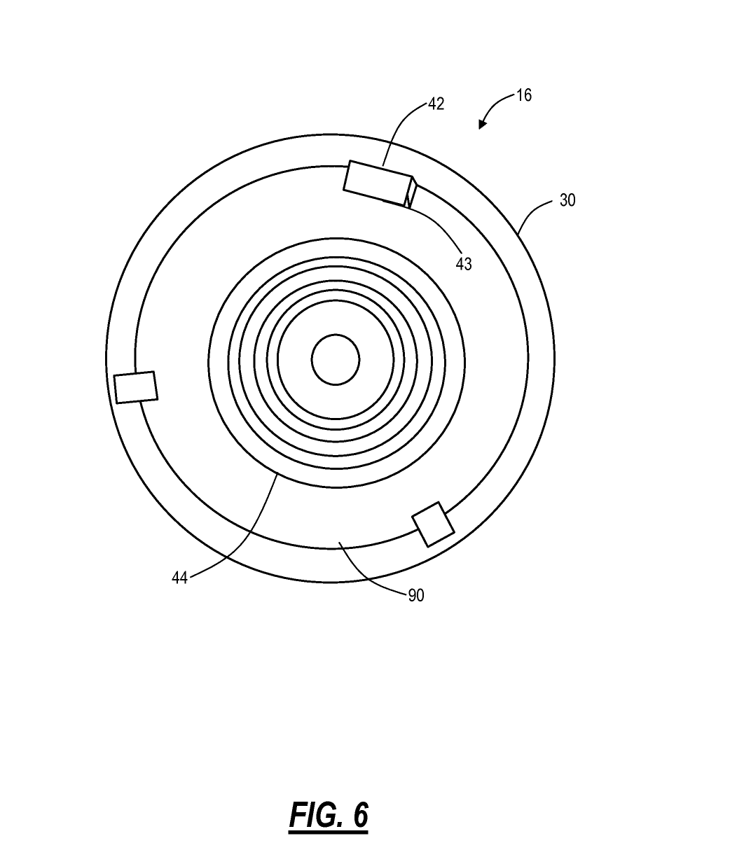

This grill assembly 30 and hinged button 32 are shown in greater detail in FIGS. 4 and 5. The speaker 26 and battery 28 are preferably disposed in conformal (i.e. substantially circular) wells 34 and 36 manufactured into the grill assembly 30 during the assembly process. This provides proper electrical contact alignment (i.e. with the printed circuit board 40 (FIG. 6)) for later steps. The well 34 for the speaker, for example, includes a plurality of sound-transmissive ports 38 through the grill assembly 30. In general, each of the wells 34 and 36 consists of a peripheral wall 39 that is shaped and sized to receive the associated component during assembly. The hinged button 32 of the grill assembly 30, in this exemplary embodiment, includes a hinged plastic cut-out associated with the grill assembly 30 and one or more raised structures, both internal and external to the grill assembly 30. These external raised structures are operable for the selective activation of the audio system 16 of the bottle assembly 10 by a patient or other user. These internal raised structures are operable for the corresponding selective activation of the components of the printed circuit board 40. The hinged button 32 of the grill assembly may be formed via a molding process using inserts to create a three-sided, single-hinged lever arm, for example, although other suitable configurations may be utilized.

Referring to FIGS. 4-6, in one exemplary embodiment, the grill assembly 30 retains the printed circuit board 40 that stores the audio data in a memory store (i.e. a memory chip or the like) and otherwise electronically couples the components of the audio system 16, providing programming/recording and playback functionality. Specifically, the printed circuit board 40 is retained by the grill assembly 30 via one or more retaining arms 42 each including a hook portion 43, similar to the one or more retaining arms 24 and hook portions 25 described above. Once “snapped” into place, the printed circuit board 40 properly electrically couples the speaker 26, the battery 28, and all of the other electronic components of the audio system 16 of the bottle assembly 10 via appropriate electrical contact points. The printed circuit board 40 also includes one or more activation buttons that physically communicate with the hinged button 32 of the grill assembly 30 and are selectively depressed thereby to play the audio data.

Referring to FIG. 6, in one exemplary embodiment, opposite the one or more buttons, the other side of the printed circuit board 40 includes a plurality of concentrically-arranged electrical contact surfaces 44 that selectively engage a line or other arrangement of external pins that are used to program the audio system 16 during the programming process prior to shipping using an external computer. During the filling process, the audio system 16 is typically programmed as the bottle label is generated and affixed, before the audio system 16 is coupled to the lower chamber or recess 14 of the bottle assembly 10. This provides a security check as to the contents of the bottle. In this regard, the “puck” that comprises the audio system 16 is contacted with the external pins via a conveyor and/or other retention system, the external pins making electrical contact with the concentrically-arranged electrical contact surfaces 44 and providing the programming using associated software. In an exemplary embodiment, the concentrically-arranged electrical contact surfaces 44 include six (6) contact rings that provide the electrical contacts for programming.

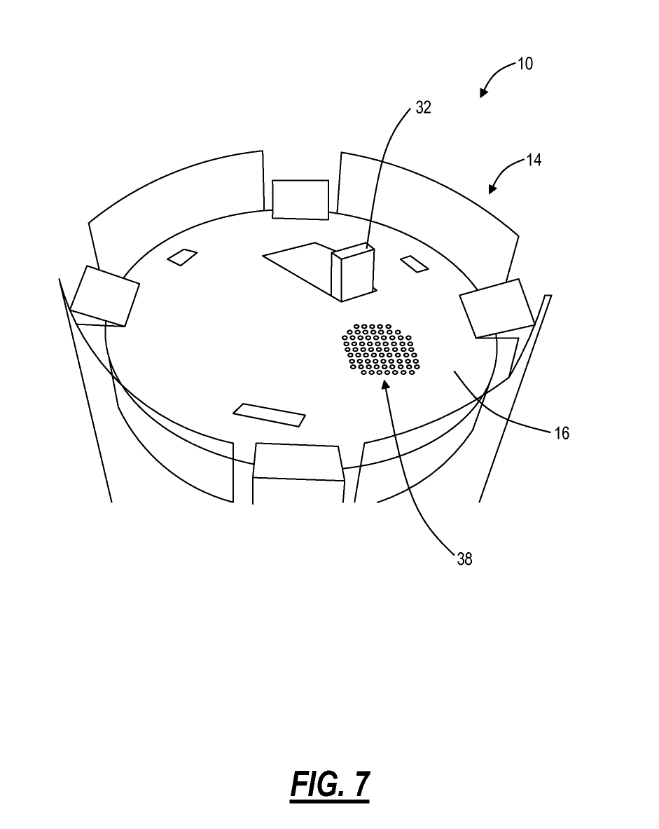

During assembly, the following steps are preferably followed, resulting in the assembled bottle assembly 10 of the present invention:
1) The speaker 26 and battery 28 are disposed in the grill assembly 30;
2) The printed circuit board 40 is mated to the grill assembly 30, providing electrical contact with the speaker 26 and the battery 28 and physical contact between the hinged button 32 and one or more buttons;
3) The resulting audio system “puck” is programmed via exposure of the concentrically-arranged electrical contact surfaces 44 of the printed circuit board 40 to the external programming pins; and
4) The audio system “puck” is “snapped” into the lower chamber or recess 14 of the bottle assembly 10.
   This finished product is illustrated in FIG. 7.

When the hinged button 32 of the audio system 16 is depressed by a patient or other user, a pre-programmed audio message is heard through the plurality of sound-transmissive ports 38.

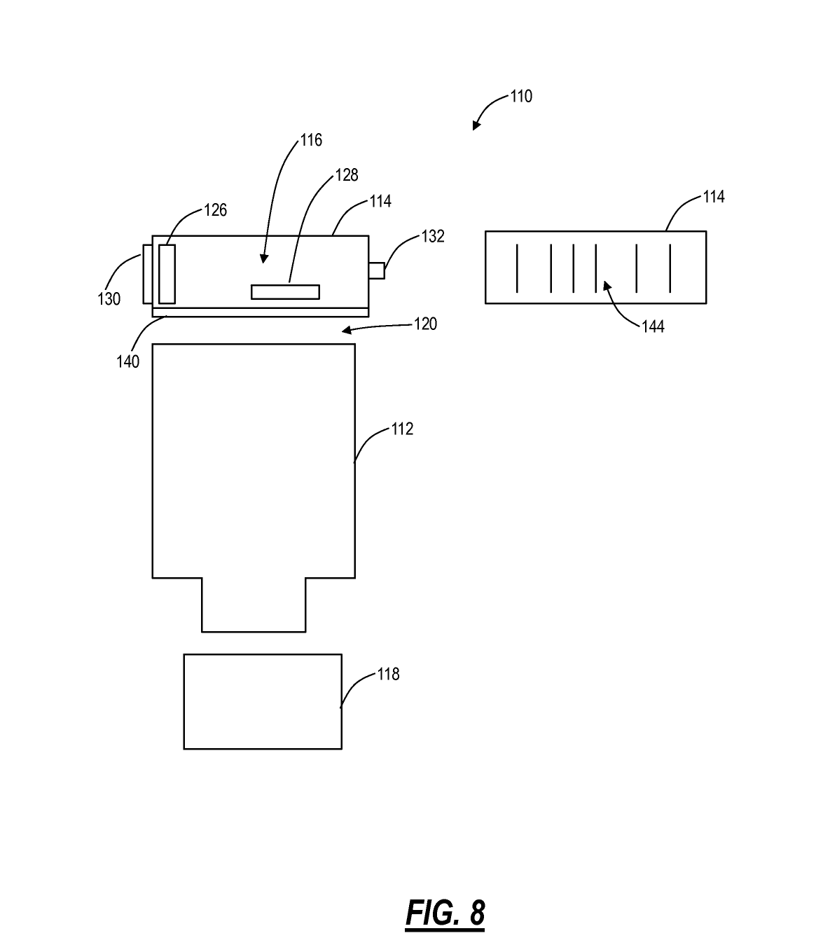

Referring to FIG. 8, in another exemplary embodiment, the present invention provides a bottle assembly 110 for containing a prescription medication or other identifiable contents that includes a lower chamber 112 separated from an upper chamber 114, wherein the two compartments or portions are axially aligned. In this regard, the bottle assembly 110 resembles a conventional pill bottle or the like, with a generally rectangular and/or tapering configuration, for example. It may be constructed of a moldable or formable plastic material or the like. The lower chamber 112 houses the prescription medication or other identifiable contents and the upper chamber 114 houses the components of the audio system 116. Accordingly, the lower chamber 112 includes a child-proof cap 118 or the like that is selectively used to close it. The lower and upper chambers 112 and 114 may be formed by separate housings that are subsequently joined together, for example, such as by “snapping” them together. Generally, the lower and upper chambers 112 and 114 are separated by one or more dividing walls 120. As used herein, “lower” and “upper” chambers are also intended to denote comparable separate compartments in other configurations, such that their vertical arrangement may be switched, they may be side by side, etc. In this sense, “lower” and “upper” are intended to cover all equivalent configurations and are relativistic only.

The digital sound system 116 generally includes a speaker 126 and a battery 128 that are selectively secured within the upper chamber 114 adjacent to a grill assembly 130 and a button 132 that protrudes through a top or side wall of the upper chamber 114, thereby providing user access to the button 132.

A printed circuit board 140 is disposed within the bottom of the upper chamber 114 (and is accessible there through) and stores audio data in a memory store (i.e. a memory chip or the like) and otherwise electronically couples the components of the audio system 116, providing programming/recording and playback functionality. The printed circuit board 140 includes a plurality of substantially parallel electrical contact surfaces 144, in either a substantially vertical or substantially horizontal arrangement, that selectively engage a line or other arrangement of external pins that are used to program the audio system 116 during the programming process prior to shipping or delivery using an external computer and appropriate software. During the filling process, the audio system 116 is typically programmed as or after the bottle label is generated and affixed, before the audio system 116 is coupled to the lower chamber 112 of the bottle assembly 110, optionally by means of a scanned barcode, as is described in greater detail herein below. This provides a security check as to the contents of the bottle. Thus, the audio system 116 is selectively contacted with the external pins via a retention system, the external pins making electrical contact with the electrical contact surfaces 144 and providing the programming using associated software. In an exemplary embodiment, the electrical contact surfaces 144 include six (6) strips that provide the electrical contacts for programming.

When the button 132 of the audio system 116 is depressed by a patient or other user, a pre-programmed audio message is heard through the grill 130.

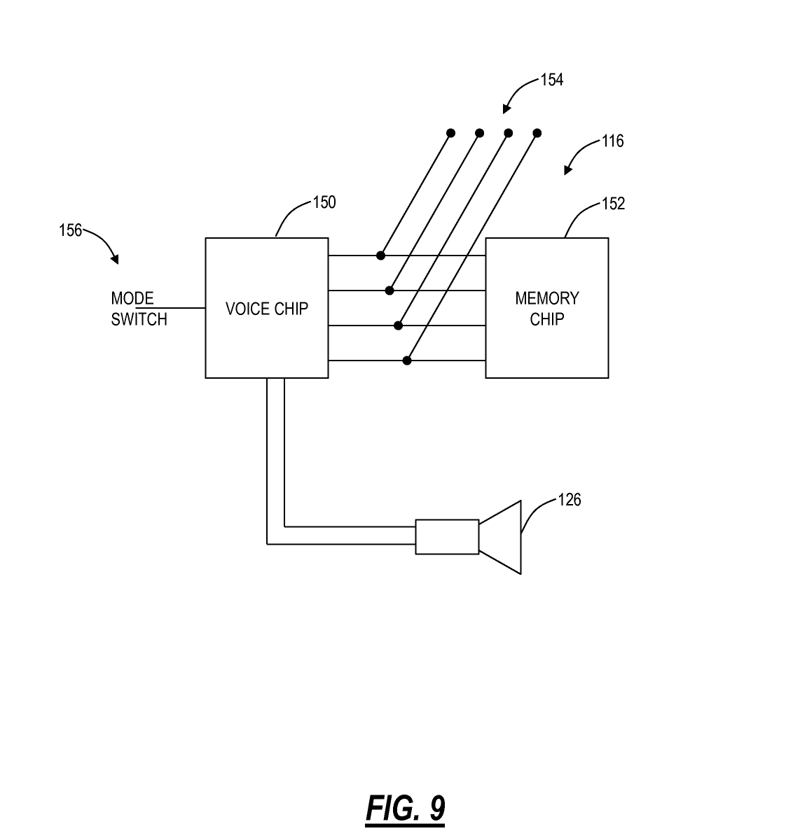

Referring to FIG. 9, in one exemplary embodiment, the audio system 16 and 116 includes a voice chip 150 and a separate but connected memory chip 152, such as a flash memory chip or the like. Audio data is dumped to the memory chip 152 via a 4-pin connection 154, for example, while a mode switch 156 associated with the voice chip 150 is set to standby. This procedure, along with clock speed control, shortens conventional programming times from about 45 seconds to about 1 second. In general, prior to programming, string data is converted using a text-to-speech module, which converts the string data to a binary file for upload.

In general, the talking pill bottle 200 of the present invention is programmed using a programming station, licensed to a pharmacy or the like, and must interface with the pharmacy's software. The present invention contemplates two different exemplary methods for interfacing the pharmacy's software to the programming station, although these exemplary methods are intended to be non-limiting. The programming station may be single or multiple-location. In general, as an alternative, a barcode is scanned into the programming station from the prescription label by the pharmacy staff, thereby telling the programming station what audio data to encode. This barcode is provided by the product provider and embedded into the pharmacy's software.

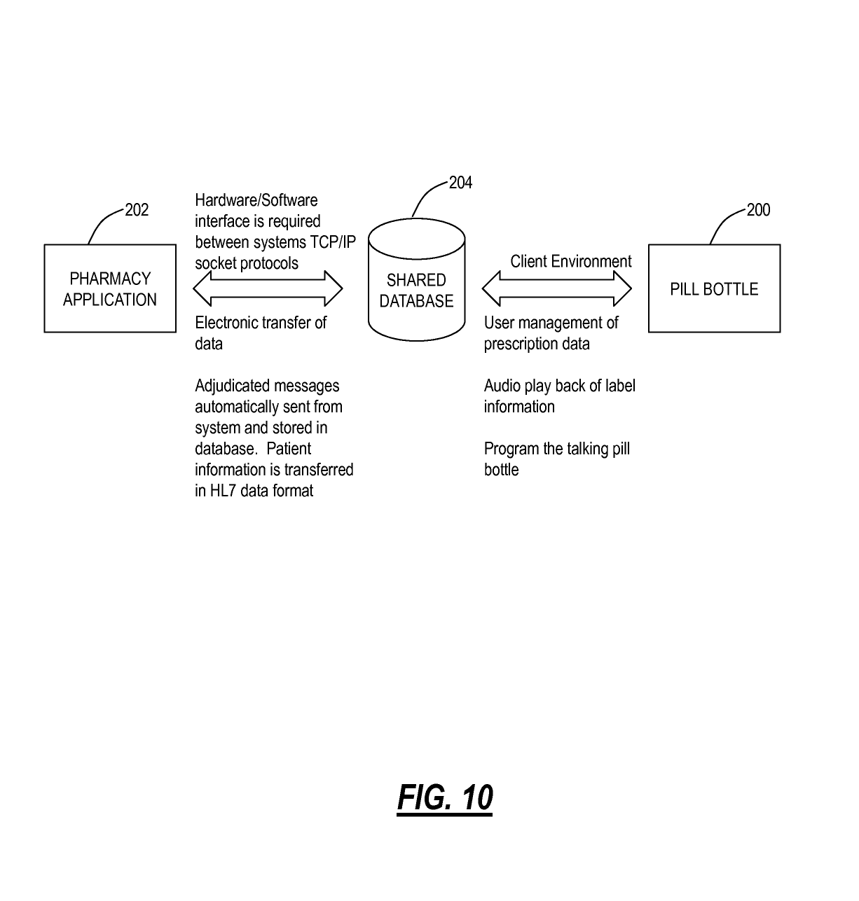

Referring to FIG. 10, in one exemplary embodiment, a hardware/software interface is established between the pharmacy application 202 and the product provider shared database 204 to allow the real time transfer of electronic patient data once a prescription has been adjudicated and is ready to be filled by the pharmacy. For example, this is accomplished using TCP/IP socket protocols. Patient information is transferred in HL7 data format, for example, and stored in the product provider shared database 204. The pharmacy staff then places the talking pill bottle 200 onto the programming station and indicates that the talking pill bottle 200 is ready to be programmed. A product provider client application parses the patient prescription data and generates a text-to-speech conversion and speech data is uploaded to the talking pill bottle 200. The pharmacy staff then removes the talking pill bottle 200 from the programming station and tests the speech for compliance to meet the pharmacy's prescription control standards.

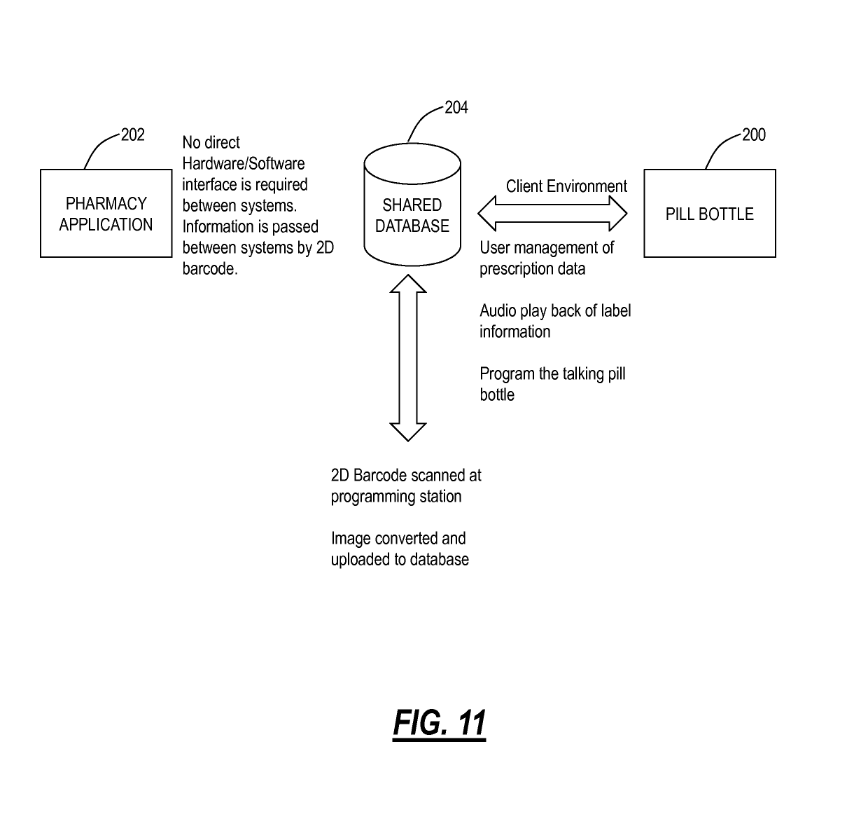

Referring to FIG. 11, in another exemplary embodiment, no direct hardware/software interface is required between the pharmacy application 202 and the product provider shared database 204. The pharmacy application 202 generates a barcode of the patient prescription information that is printed on the pill bottle label, for example. The barcode is scanned into the programming station and the patient information is automatically uploaded to the product provider shared database 204. The talking pill bottle 200 is then placed into the programming station and the talking pill bottle 200 is programmed with the appropriate audio data. The product provider client application parses the patient prescription data and generates the text-to-speech conversion and the speech data is uploaded to the talking pill bottle 200. The pharmacy staff then removes the talking pill bottle 200 from the programming station and tests the speech for compliance to meet the pharmacy's prescription control standards.

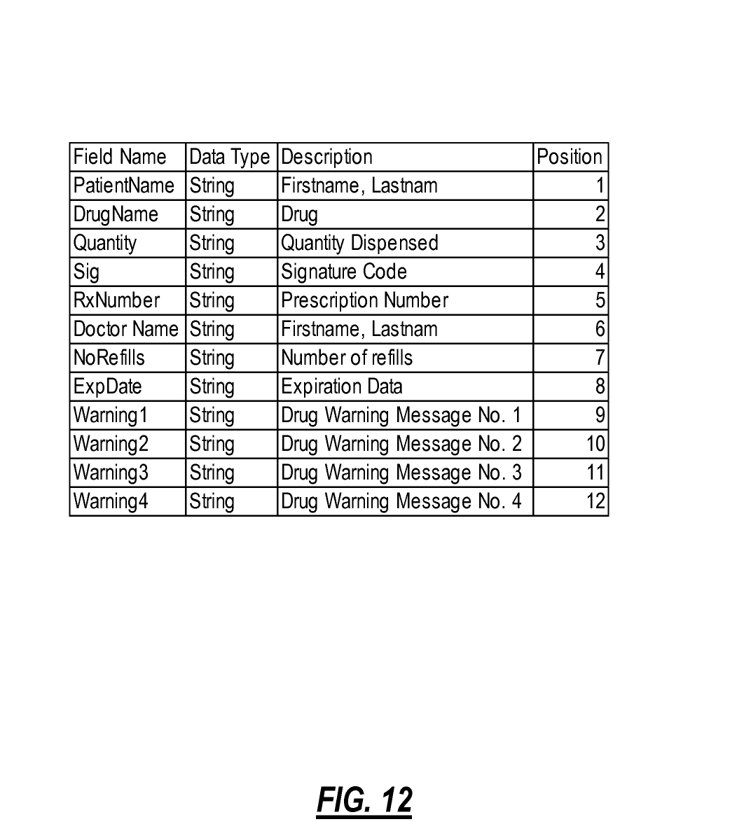

An exemplary barcode record layout is provided in FIG. 12.

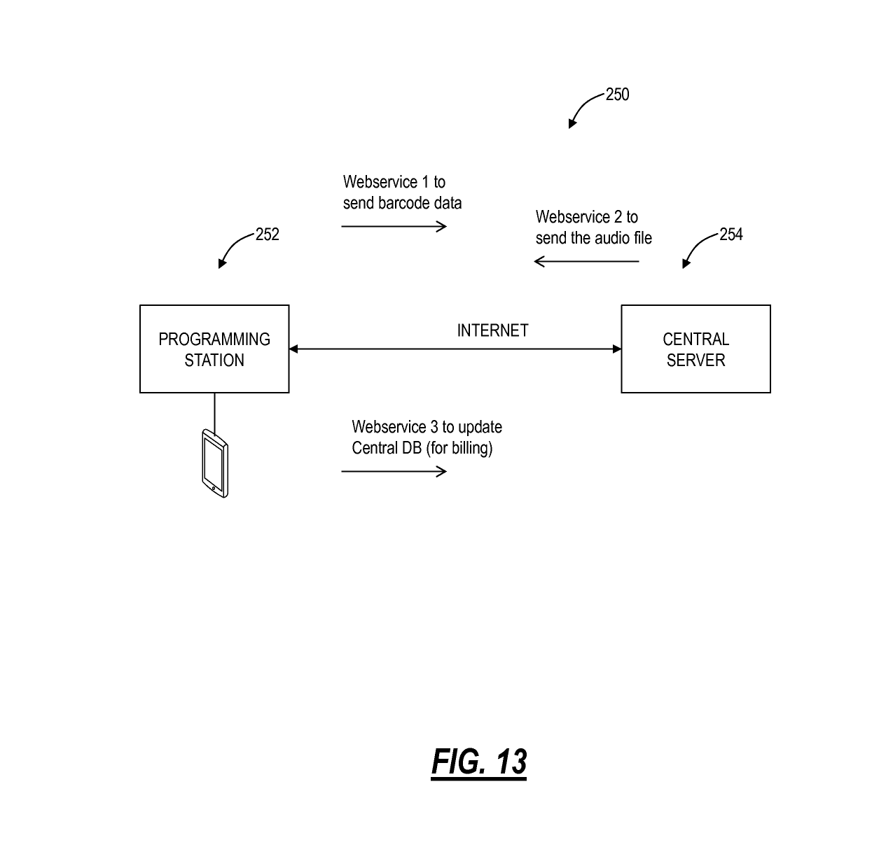

Referring to FIG. 13, in a further exemplary embodiment, the smart pill bottle application framework 250 of the present invention includes scanning the two dimensional barcode present on the pill bottle label using a tablet camera or the like 252. This scanned barcode is used to retrieve the patient prescription, which is parsed. A webservice is then created and filled with the patient data, with the webservice subsequently sent to the central server 254. The central server 254 then passes the patient data to text-to-speech software, which creates an audio file. The central server 254 then creates a webservice and fills it with the audio file, which is sent back to the pharmacy tablet 252. The audio file is processed and a programming environment is created to program the voice chip associated with the pill bottle. If this programming is successful, then the pharmacy tablet 252 creates a webservice that is sent to the central server 254 to update the successful filling of the prescription, which may then be billed. The pharmacist has the option of adjusting the phonics of drug names, patient names, doctor names, etc. This information is also transferred to a webservice including the new spelling structures, etc., which is sent to the central server 254 to update the phonics database, such that drug names, patient names, doctor names, etc. are properly pronounced once programmed.

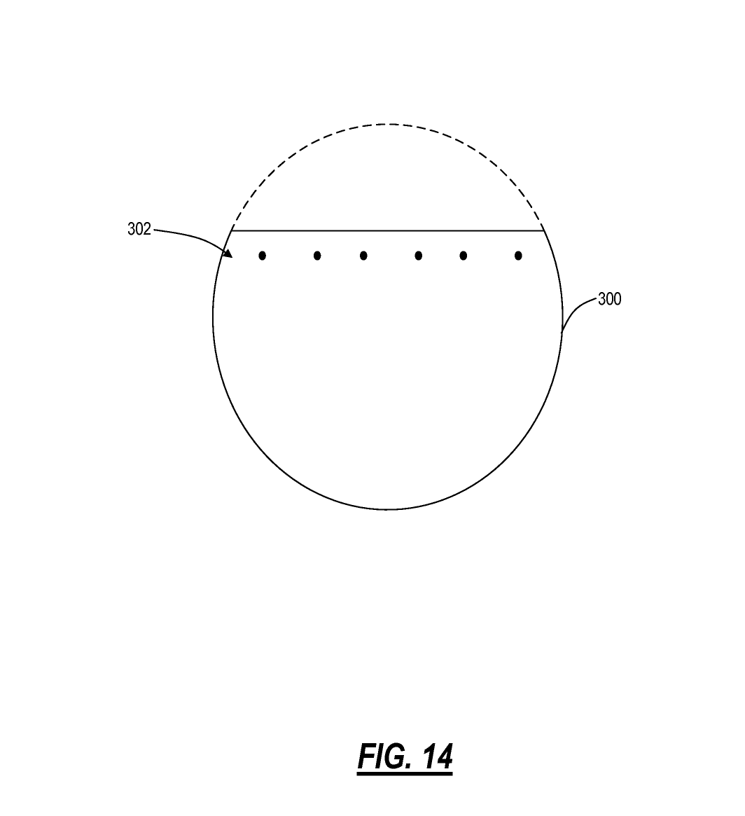

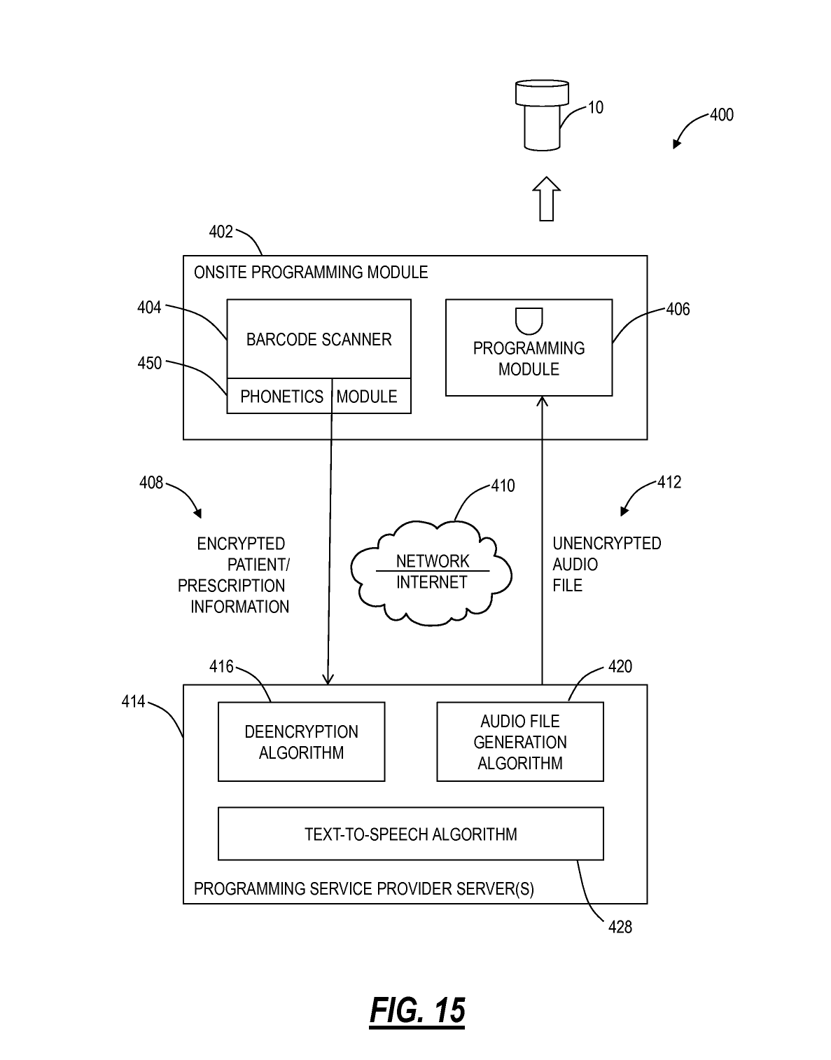

Referring to FIG. 14, in a further exemplary embodiment, the audio system 300 (which is similar in many respects to the other audio systems described above and may share some or all of their components) has a keyed shape that forms any portion of a circle or all or any portion of another shape, matching and making the audio system 300 compatible with the bottom of a circular or other shaped pill bottle or the like for engagement purposes. The keyed shape, however, is intended to match a similarly keyed receptacle associated with an onsite programming module 402 (FIG. 15), such that the audio system 300, when detached from the pill bottle or the like, may only be coupled to the onsite programming module 402 in one specific orientation. In this manner, proper alignment of the programming contacts 302 of the audio system 300 and the programming pins of the onsite programming module 402 is ensured. In the exemplary embodiment illustrated, a line of programming contacts 302 is provided, although other desired configurations could also be utilized, provided that the keyed feature ensures proper alignment.

Referring to FIG. 15, in a further exemplary embodiment, the onsite programming module 402 is placed at a pharmacy or the like. The onsite programming module 402 includes a barcode scanner 404 for scanning two-dimensional barcodes or the like of the kind normally used by the pharmacy, thereby transferring a patient name, prescription information, etc. into the onsite programming module 402. Once this information is captured, a pharmacist may hear a preview of portions of the eventual audio file that will be created, such as the pronunciation of a patient's or medicine's name. This pronunciation may then be phonetically modified using the phonetics module 450, with this new information stored and implemented to create a “learning” system. This is especially useful for foreign and complicated names. The audio file samples may be generated locally at the onsite programming module 402 or may be generated remotely at the programming service provider server(s) 414. Advantageously, the onsite programming module 402 allows the programming service provider to maintain isolation from the pharmacist's patient databases.

The onsite programming module 402 sends all information to the programming service provider server(s) 414 via encrypted means 408 over the Internet or another network 410. The programming service provider server(s) 414 operate a decryption algorithm 416, a text-to-speech algorithm 428, and an audio file generation algorithm 420 that collectively turn the information into an audio file 412 that is transmitted back to the onsite programming module 402 via the Internet or another network 410, although this transmission may be unencrypted. The audio file 412 is then programmed into the pill bottle audio system 300 using the programming module 406, prior to the audio system 300 being affixed to the pill bottle.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A container assembly that selectively provides an audio message related to its contents, comprising:
a first housing configured to contain the contents;
a second housing coupled to the first housing;
an audio system selectively attached to the second housing;
a printed circuit board disposed within the audio system and comprising a memory configured to receive audio data; and
a speaker and a battery disposed within the audio system and coupled to the printed circuit board;
wherein the audio system has a keyed shape and is configured to mate with a similarly-shaped receptacle of an audio data programming system when the audio system is detached from the second housing.

2. The container assembly of claim 1, wherein the first housing and the second housing are integrally formed.

3. The container assembly of claim 1, wherein the first housing and the second housing are separately formed.

4. The container assembly of claim 1, wherein a wall of the second housing defines one or more leg members and one or more retention members configured to retain the audio system.

5. The container assembly of claim 1, wherein the printed circuit board comprises at least one button configured to selectively activate and play the audio data programmed into the memory.

6. The container assembly of claim 5, wherein the speaker and the battery are disposed within an interior surface of the audio system, and wherein the interior surface of the audio system comprises at least one button corresponding to the at least one button of the printed circuit board.

7. The container assembly of claim 1, wherein the contents comprise a medication.

8. The container assembly of claim 1, wherein the printed circuit board comprises a plurality of contacts that are accessible through the audio system by which the audio data programmed into the memory is programmed by the audio data programming system.

9. The container assembly of claim 8, wherein the plurality of contacts are linearly aligned or aligned in another fixed pattern.

10. The container assembly of claim 1, wherein the audio system has a keyed shape such that it may be mated with the audio data programming system in only one orientation for programming.

11. The container assembly of claim 1, wherein the audio data programming system is disposed within a pharmacy and the audio data is generated one or more of outside of and inside the pharmacy.

12. A method for programming a container assembly that selectively provides an audio message related to its contents, comprising:
receiving information related to the contents into a locally-disposed programming module;
transmitting the information related to the contents to a remotely-disposed programming service provider system;
at the remotely-disposed programming service provider system, converting the information related to the contents into an audio file using a text-to-speech conversion algorithm;
transmitting the audio file to the locally-disposed programming module; and
at the locally-disposed programming module, programming an audio system of the container assembly using the audio file.

13. The method of claim 12, further comprising previewing a portion of the audio file at the locally-disposed programming module.

14. The method of claim 13, further comprising modifying a portion of the information related to the contents responsive to the previewed audio file.

15. The method of claim 12, further comprising encrypting the information related to the contents.

16. The method of claim 15, further comprising at the remotely-disposed programming service provider system, decrypting the information related to the contents.

17. The method of claim 12, wherein the audio system has a keyed shape such that it may be mated with the locally-disposed programming module in only one orientation for programming.

18. The method of claim 12, wherein receiving the information related to the contents into the locally-disposed programming module comprises receiving the information related to the contents into the locally-disposed programming module from one or more of a one-dimensional barcode and a two-dimensional barcode.
